(19) United States
(12) Patent Application Publication
(10) Pub. No.: US 2010/0002212 A1
(43) Pub. Date: Jan. 7, 2010

(54) SCANNING EXPOSURE APPARATUS, EXPOSURE METHOD, AND DEVICE MANUFACTURING METHOD

(75) Inventors: Tomohiro Harayama, Utsunomiya-shi (JP); Youzou Fukagawa, Utsunomiya-shi (JP); Yukio Takabayashi, Saitama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/495,792

(22) Filed: Jun. 30, 2009

(30) Foreign Application Priority Data
Jul. 3, 2008 (JP) 2008-174564

(51) Int. Cl. G03B 27/42

(52) U.S. Cl. 355/53; 355/72

(57) ABSTRACT

An apparatus includes a control unit configured to control an exposure unit and a driving unit such that exposure of a first region of a substrate starts and ends while a substrate stage is accelerated in a first direction parallel to a scanning direction, an absolute value of maximum acceleration of the substrate stage during a deceleration period is greater than an absolute value during a first approach run period, and a distance by which the substrate stage moves during the first approach run period is approximately equal to a distance by which the substrate stage moves during the deceleration period.

### BACKGROUND OF THE INVENTION

1. Field of the Invention

The present invention relates to a scanning exposure apparatus used in a lithography process for manufacturing semiconductor devices. The present invention also relates to an exposure method and a device manufacturing method both using the exposure apparatus.

2. Description of the Related Art

FIG. 5 illustrates an example of a scanning exposure apparatus. A light beam 2 from a light source 1 passes through an illumination optical system 3, an opening in a shield 4, and an illumination optical system 5, so that a reticle (original) 6 is irradiated with the light beam 2. The light beam 2 having passed through the reticle 6 further passes through a projection optical system 7, so that a wafer (substrate) 8 is irradiated with the light beam 2. Since the light beam 2 is partially cut off by the shield 4 capable of being driven, the reticle 6 and the wafer 8 are irradiated with slit-like light.

The reticle 6 is mounted on a movable reticle stage 9. The wafer 8 is mounted on a movable wafer stage 10. The positions of the reticle stage 9 and the wafer stage 10 are measured by a laser interferometer 13 and a laser interferometer 14, respectively. The reticle stage 9 and the wafer stage 10 are driven by a linear motor 11 and a linear motor 12, respectively.

The projection optical system 7 includes a plurality of lenses 18 and an aberration correcting mechanism 17. The aberration correcting mechanism 17 corrects aberration of the projection optical system 7 by varying pressure between at least two of the plurality of lenses 18 or by varying the position of at least one of the plurality of lenses 18.

A controller 15 controls the linear motors 11 and 12 on the basis of outputs of the laser interferometers 13 and 14 so as to cause the stages 9 and 10 to perform scanning movements in synchronization with each other. Also, the controller 15 controls the light source 1, the illumination optical systems 3 and 5, and the shield 4 so as to synchronize exposure with the scanning movements of the stages 9 and 10.

FIG. 6 is a graph showing a relationship between time and velocity of the wafer stage 10 of the related art, during one scanning exposure process. At time T=t₀, the wafer 8 is placed on the wafer stage 10. The wafer 8 is aligned during a period from time T=t₀ to time T=t₁. The wafer stage 10 is accelerated during a period from time T=t₁ to time T=t₄, driven at a constant velocity during a period from time T=t₄ to time T=t₆ or from time T=t₅ to time T=t₆ (described below), and decelerated during a period from time T=t₆ to time T=t₇.

Exposure is performed in the period from time T=t₅ to time T=t₆ during which the wafer stage 10 is moved at a constant velocity. When the amount of exposure per unit time is constant, the wafer 8 can be exposed uniformly.

When the wafer stage 10 changes from an accelerated state to a constant velocity state, the amount of force applied from a driving mechanism to the wafer stage 10 changes. As a result, immediately after entering the constant velocity state, the wafer stage 10 may be deformed or vibrated by the change in applied force. Therefore, there is provided a stabilization period from time T=t₄ to time T=t₅ during which exposure is not performed. Additionally, to slow down the change in applied force, there is provided a jerk period from time T=t₃ to time T=t₄ during which a change in acceleration is slowed down.

Japanese Patent Laid-Open No. 09-223662 describes a technique in which exposure is performed when a wafer stage is in both an acceleration state and a deceleration state. Specifically, in this technique, the amount of exposure per unit time is varied in accordance with the velocity of the wafer stage, so that a wafer can be exposed uniformly. This technique makes it possible to achieve throughput higher than that in the case of FIG. 6.

To improve throughput in the related art described above, it is desirable to perform exposure when the wafer stage 10 is in both the acceleration and deceleration states, as described in Japanese Patent Laid-Open No. 09-223662.

However, in the technique described in Japanese Patent Laid-Open No. 09-223662, since exposure is performed when the wafer stage changes from an accelerated state to a constant velocity state, the resulting deformation or vibration of the wafer stage may cause degradation in exposure performance.

The present invention has been made in view of the circumstances described above. The present invention provides a technique for improving throughput of a scanning exposure apparatus while minimizing degradation of exposure performance caused by deformation and vibration.

### SUMMARY OF THE INVENTION

The present invention provides an apparatus including a substrate stage, a driving unit configured to drive the substrate stage in a scanning direction, an exposure unit configured to irradiate the substrate with light for exposure, and a control unit configured to control the exposure unit and the driving unit. The control unit controls the exposure unit and the driving unit such that exposure of a first region of the substrate starts and ends while the substrate stage is accelerated in a first direction parallel to the scanning direction; such that an absolute value of maximum acceleration of the substrate stage during a deceleration period is greater than an absolute value during a first approach run period, the first approach run period being a period from a time when a velocity of the substrate stage is zero and acceleration starts to a time when exposure of the first region starts, the deceleration period being a period from a time when exposure of the first region ends and deceleration starts to a time when the velocity becomes zero; and such that a distance by which the substrate stage moves during the first approach run period is approximately equal to a distance by which the substrate stage moves during the deceleration period.

Further features of the present invention will become apparent from the following description of exemplary embodiments with reference to the attached drawings.

### BRIEF DESCRIPTION OF THE DRAWINGS

FIG. 1 illustrates a relationship between time and velocity of a wafer stage according to a first exemplary embodiment of the present invention.

FIG. 2 is a diagram showing times and directions in which the wafer stage of the first exemplary embodiment is driven.

FIG. 3 is a flowchart illustrating a process for calculating a target signal for driving the wafer stage according to the first exemplary embodiment.

FIG. 4 illustrates a relationship between time and velocity of a wafer stage according to a second exemplary embodiment of the present invention.

FIG. 5 is a schematic diagram illustrating a scanning exposure apparatus.

FIG. 6 is a graph showing a relationship between time and velocity of a known wafer stage during one scanning exposure process.

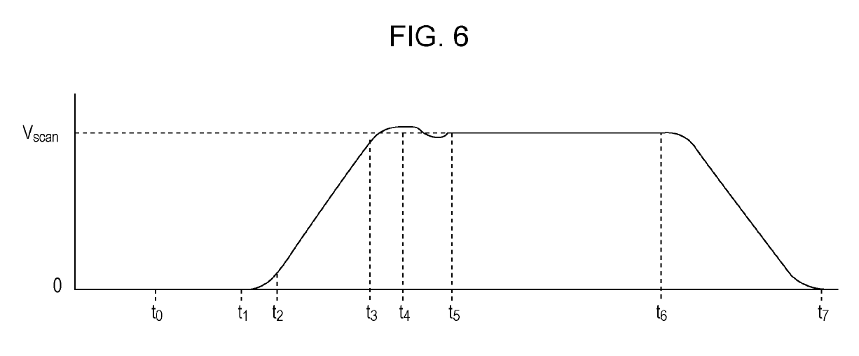

FIG. 7 illustrates a relationship between time and velocity of a known wafer stage.

### DESCRIPTION OF THE EXEMPLARY EMBODIMENTS

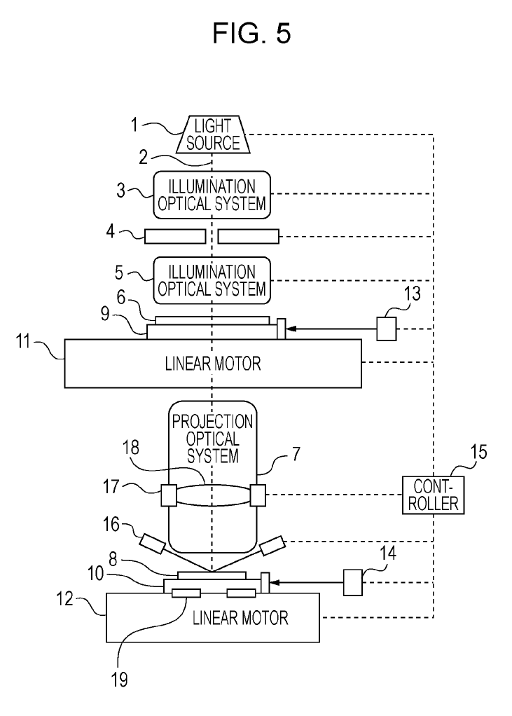

FIG. 5 illustrates an example of a scanning exposure apparatus. A light beam 2 from a light source 1 passes through an illumination optical system 3, a shield 4 having an opening, and an illumination optical system 5, so that a reticle (original) 6 is irradiated with the light beam 2. The light beam 2 having passed through the reticle 6 further passes through a projection optical system 7, so that a wafer (substrate) 8 is irradiated with the light beam 2. Since the light beam 2 is partially cut off by the shield 4 capable of being driven, the reticle 6 and the wafer 8 are irradiated with slit-like light.

The reticle 6 is mounted on a movable reticle stage 9. The wafer 8 is mounted on a movable wafer stage (substrate stage) 10 while being held by a holding unit (not shown). The positions of the reticle stage 9 and the wafer stage 10 are measured by a laser interferometer 13 and a laser interferometer 14, respectively. The reticle stage 9 and the wafer stage 10 are driven by a linear motor 11 and a linear motor 12, respectively, in a scanning direction. Driving units for driving the stages 9 and 10 are not limited to the linear motors 11 and 12. Known mechanisms, such as ball screws, may be used as the driving units. The scanning exposure apparatus further includes a brake mechanism 19 for decelerating and stopping the wafer stage 10. Examples of the brake mechanism 19 include known brakes, such as a brake using friction, a brake using an air damper, a brake using electromagnetic force, a brake using a spring, and a dynamic brake.

The projection optical system 7 includes a plurality of lenses 18 and an aberration correcting mechanism 17. The aberration correcting mechanism 17 corrects aberration of the projection optical system 7 by varying pressure between at least two of the plurality of lenses 18 or by varying the position of at least one of the plurality of lenses 18. The lens position includes a horizontal position, a vertical position, and a rotational position.

A controller (control unit) 15 controls the linear motors 11 and 12 on the basis of outputs of the laser interferometers 13 and 14 so as to cause the stages 9 and 10 to perform scanning movements in synchronization with each other. Also, the controller 15 controls an exposure unit for irradiating the wafer 8 with light for exposure, so as to synchronize exposure with the scanning movements of the stages 9 and 10. In the present exemplary embodiment, the exposure unit includes the light source 1, the illumination optical systems 3 and 5, the shield 4, and the projection optical system 7. However, the exposure unit is not limited to this, and may vary depending on the configuration of the exposure apparatus. For example, the present invention is also applicable to an exposure apparatus configured to perform exposure using charged particles. Although the controller 15 is illustrated as a single unit in FIG. 5, the controller 15 may be configured as a plurality of controllers capable of communicating with each other and individually controlling the light source 1, the shield 4, the stages 9 and 10, and the aberration correcting mechanism 17. A known controller including a processor and a memory may be used as the controller 15.

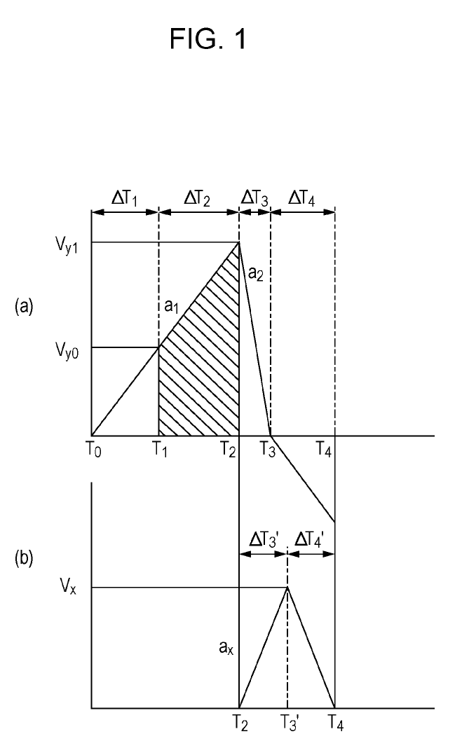

With reference to FIG. 1, an exposure method according to the present exemplary embodiment will be described. FIG. 1 illustrates a relationship between time and velocity of the wafer stage 10 according to the present exemplary embodiment. In FIG. 1, (a) shows the velocity of the wafer stage 10 in the Y direction (scanning direction), and (b) shows the velocity of the wafer stage 10 in the X direction (orthogonal to the scanning direction).

At time T=T₀ when the velocity of the wafer stage 10 in the scanning direction is zero, the acceleration of the wafer stage 10 in the scanning direction starts. Exposure starts at time T=T₁ and ends at time T=T₂. Then, at time T=T₂, the deceleration of the wafer stage 10 starts. In other words, the acceleration of the wafer stage 10 in a direction opposite the direction of the scanning exposure starts at time T=T₂. At time T=T₃, the velocity of the wafer stage 10 in the scanning direction becomes zero. The acceleration of the wafer stage 10 in the direction opposite the scanning direction continues until time T=T₄.

Here, the period from time T₀ to time T₁ is defined as a first approach run period ΔT₁, the period from time T₁ to time T₂ is defined as an exposure period ΔT₂, the period from time T₂ to time T₃ is defined as a deceleration period (first deceleration period) ΔT₃, and the period from time T₃ to time T₄ is defined as a second approach run period ΔT₄. The velocity of the wafer stage 10 at time T=T₁ is denoted by V_{y0}, and the velocity of the wafer stage 10 at time T=T₂ is denoted by V_{y1}. The acceleration of the wafer stage 10 during the first approach run period ΔT₁ and the exposure period ΔT₂ (i.e., first acceleration) is denoted by a₁, and the acceleration of the wafer stage 10 during the deceleration period ΔT₃ (i.e., second acceleration) is denoted by a₂.

In the present exemplary embodiment, the acceleration a₁ is constant during the first approach run period ΔT₁ and the exposure period ΔT₂. Here, the expression “acceleration a₁ is constant” refers not only to the case where the acceleration a₁ is perfectly constant, but also to the case where the acceleration a₁ is substantially constant. When the amount of force applied to the wafer stage 10 during exposure is substantially constant, it is possible to reduce degradation in exposure performance caused by deformation and vibration of the wafer stage 10. Even when the acceleration of the wafer stage 10 is not (substantially) constant, since exposure starts and ends during acceleration, there is no switching from an acceleration state to a constant velocity state during exposure. Therefore, it is possible to reduce the effect of the deformation and vibration described above.

As shown in FIG. 1, the acceleration of the wafer stage 10 is changed at time T=T₂. However, since exposure is not performed in the deceleration period ΔT₃, it is not necessary to consider the effect of this change on exposure.

After completion of exposure of one region (first region), the wafer stage 10 performs step movement in the X direction. For this, the acceleration of the wafer stage 10 in the X direction starts at time T=T₂. In the X direction, the wafer stage 10 continues to be accelerated until time T=T₃′. Then, the wafer stage 10 is decelerated and stops at time T=T₄. The velocity of the wafer stage 10 at time T=T₃′ is denoted by Vₓ. The acceleration period from time T₂ to time T₃′ is denoted by ΔT₃′, and the deceleration period from time T₃′ to time T₄ is denoted by ΔT₄′.

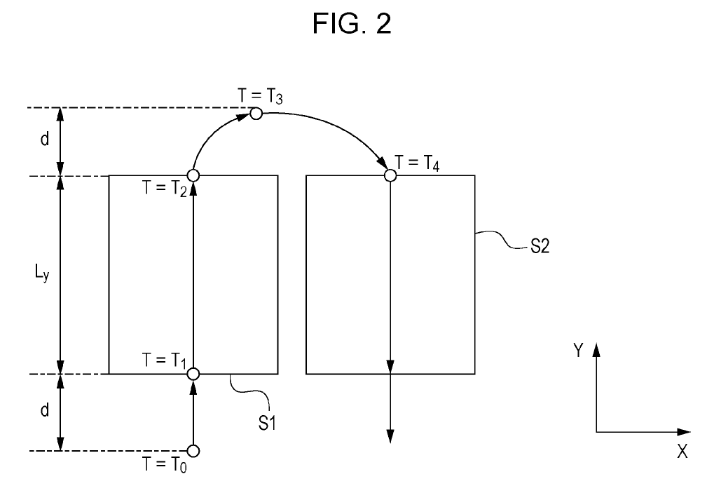

At time T=T₄, exposure of the next region (second region) starts. As illustrated in FIG. 2, the second region (S2) is adjacent to the first region (S1) in the X direction. The wafer stage 10 moves in the −Y direction (first direction) during exposure of the first region, and moves in the +Y direction (second direction) during exposure of the second region. To clearly show that the wafer stage 10 moves in two opposite directions, the directions are described with plus (+) and minus (−) signs. Although the wafer stage 10 moves in reality, a path of slit-like light is indicated by arrows in FIG. 2.

An absolute value of the acceleration in the second approach run period ΔT₄ is equal to an absolute value of the acceleration in the first approach run period ΔT₁. Here, the expression “absolute values of (two) accelerations are equal” refers not only to the case where they are equal, but also to the case where they are substantially equal.

After the second approach run period ΔT₄, as in the case of the first region, exposure starts and ends during acceleration of the wafer stage 10. The same operation is performed on subsequent regions to be exposed adjacent to each other in the X direction.

Exposure is performed such that a distance by which the wafer stage 10 moves in the Y direction during the deceleration period ΔT₃ is equal to a distance by which the wafer stage 10 moves in the Y direction during the second approach run period ΔT₄. Here, the expression “(two) distances are equal” refers not only to the case where they are equal, but also to the case where they are substantially equal. Generally, the acceleration of the wafer stage 10 during exposure of the first region is set optimally in accordance with the driving performance of the linear motors 11 and 12. When the two distances described above are equal, exposure of the second region can start at the same acceleration as that for the first region, and at the same position in the Y direction as the position at which the exposure of the first region ends.

As described above, the distance by which the wafer stage 10 moves in the Y direction during the deceleration period ΔT₃ is equal to that during the first approach run period ΔT₁. Thus, the absolute value of the maximum acceleration (a₁ here) in the first approach run period ΔT₁ is greater than the absolute value of the maximum acceleration (a₂ here) in the deceleration period ΔT₃. Therefore, in the deceleration period ΔT₃, the brake mechanism 19 assists the linear motor 11 in decelerating the wafer stage 10.

In summary, an exposure method according to the present exemplary embodiment includes an approach run step (performed in the first approach run period ΔT₁) in which the wafer stage 10 initially at rest is accelerated until exposure starts. The exposure method further includes an exposure step (performed in the exposure period ΔT₂) in which a first region of the wafer 8 is exposed while the wafer stage 10 is accelerated, and a deceleration step (performed in the deceleration period ΔT₃) in which the wafer stage 10 is decelerated after completion of the exposure. Here, an absolute value of the acceleration of the wafer stage 10 in the deceleration step is greater than an absolute value of the acceleration of the wafer stage 10 in the approach run step. At the same time, a distance by which the wafer stage 10 moves in the approach run step is equal to a distance by which the wafer stage 10 moves in the deceleration step.

In the present exemplary embodiment, the velocity of the wafer stage 10 changes during exposure. Therefore, to achieve uniform exposure of the wafer 8, the amount of exposure is controlled in the following manner. That is, on the basis of outputs of the laser interferometers 13 and 14, the controller 15 controls at least one of the light source 1, the illumination optical systems 3 and 5, and the shield 4 to control the amount of exposure. For example, in accordance with the scanning velocity, the controller 15 can change the oscillation frequency of an exposure pulse, the level of output (power), and ON/OFF timing of the light source 1. On the basis of outputs of the laser interferometers 13 and 14, the controller 15 may cause pulsed light to be emitted each time the stages 9 and 10 are moved by a predetermined distance. The controller 15 may control the rotation of a prism in the illumination optical systems 3 and 5. With any of the methods described above, it is possible to reduce the amount of exposure when the scanning velocity is small, and increase the amount of exposure when the scanning velocity is large. That is, the wafer 8 can be uniformly exposed throughout its entire region to be exposed.

For example, since exposure is performed with thrust applied to the stages 9 and 10, the exposure accuracy may be degraded by deformation of the stages 9 and 10. However, in the present exemplary embodiment, since the thrust is substantially constant and does not significantly change, the effect of the deformation can be reduced by correcting the force of constant magnitude. For example, the positions of the stages 9 and 10 or aberration of the projection optical system 7 may be corrected. The controller 15 obtains, from a focus sensor 16, the position and inclination of the wafer 8 in the vertical direction. Additionally, the controller 15 obtains, from the laser interferometer 14, the position of the wafer 8 in the horizontal direction. On the basis of the information obtained from the focus sensor 16 and the laser interferometer 14, the controller 15 obtains positional and inclination information corresponding to the position of the wafer 8 in the horizontal direction. On the basis of this information, the controller 15 controls the linear motors 11 and 12 and the aberration correcting mechanism 17 such that desirable exposure can be made.

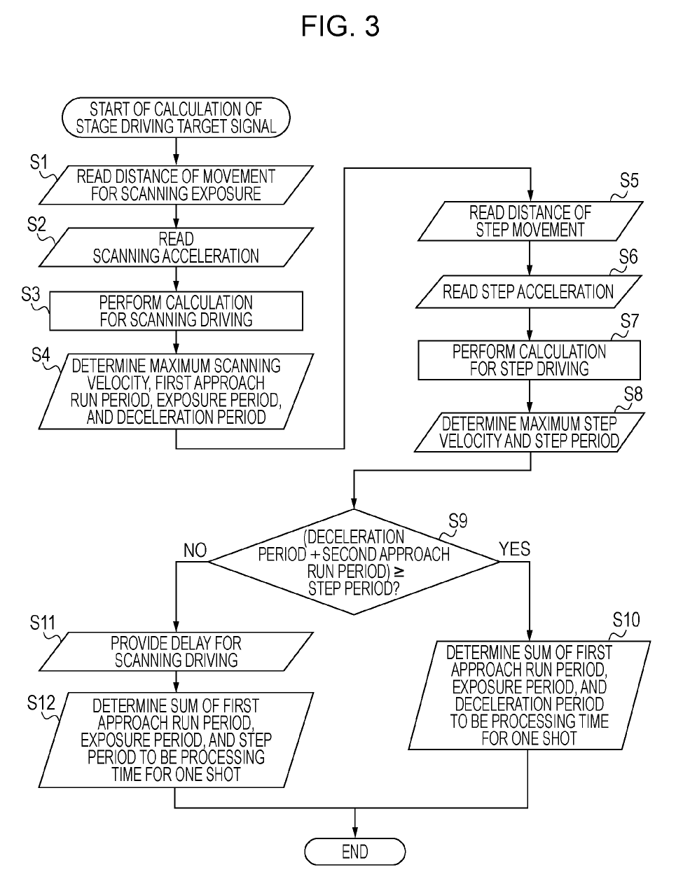

FIG. 3 is a flowchart illustrating a process for calculating a target signal for driving the wafer stage 10 according to the present exemplary embodiment. The following control is performed by the controller 15.

In step S1, a predetermined distance of movement for scanning exposure is read from a memory (not shown). In step S2, predetermined acceleration during the scanning exposure is read. The acceleration is determined in consideration of the performance of the linear motors 11 and 12 and the brake mechanism 19. In step S3, calculation is performed on the basis of the information read in steps S1 and S2. In step S4, the maximum velocity V_{y1} in the Y direction, the first approach run period ΔT₁, the exposure period ΔT₂, and the deceleration period ΔT₃ for the scanning and step movement of the wafer stage 10 are determined. The second approach run period ΔT₄ is substantially equal to the first approach run period ΔT₁.

On the basis of the calculated period of time, the controller 15 performs exposure as illustrated in FIG. 1.

In step S5, a predetermined distance of step movement is read. This distance is determined, for example, by a user's input from an input device which is configured to be able to communicate with the controller 15. In step S6, predetermined acceleration of the step movement is read. In step S7, calculation is performed on the basis of the information read in steps S5 and S6. In step S8, the maximum velocity Vₓ in the X direction during the step movement of the wafer stage 10 and a step period (ΔT₃′+ΔT₄′) are determined.

In step S9, a determination is made as to whether the sum of the deceleration period ΔT₃ and the second approach run period ΔT₄ is greater than or equal to the step period (ΔT₃′+ΔT₄′). If it is determined that the sum of the deceleration period ΔT₃ and the second approach run period ΔT₄ (ΔT₃+ΔT₄) is greater than or equal to the step period (ΔT₃′+ΔT₄′) (YES in step S9), it is possible to proceed to the next scanning exposure process immediately after completion of one scanning exposure process. That is, in step S10, the sum of the first approach run period ΔT₁, the exposure period ΔT₂, and the deceleration period ΔT₃ is determined to be processing time for one shot. If it is determined in step S9 that the period (ΔT₃+ΔT₄) is smaller than the step period (ΔT₃′+ΔT₄′) (NO in step S9), the process proceeds to step S11. In step S11, after completion of one scanning exposure process, the process waits for completion of step driving. Then, upon completion of the step driving, the process proceeds to the next scanning exposure process. That is, in step S12, the sum of the first approach run period ΔT₁, the exposure period ΔT₂, and the step period (ΔT₃′+ΔT₄′) is determined to be processing time for one shot.

Next, in the present exemplary embodiment, the time taken for one exposure process is estimated to describe the effect of the present invention.

The velocities V_{y0} and V_{y1} can be expressed by the following equations:

V_{y0}=a₁ΔT₁ (1)

V_{y1}=a₁(ΔT₁+ΔT₂) (2)

where a₁ denotes acceleration of the wafer stage 10 during the first approach run period ΔT₁.

The following equation holds true:

V_{y1}=a₁(ΔT₁+ΔT₂)=a₂ΔT₃ (3)

where a₂ denotes acceleration of the wafer stage 10 during the deceleration period ΔT₃.

The following equation holds true:

(V_{y0}+V_{y1})×ΔT₂=2L_{y} (4)

where L_{y} denotes a distance of a region to be exposed in the Y direction.

The following equation holds true, because the distance by which the wafer stage 10 moves during the deceleration period ΔT₃ in the Y direction is equal to the distance by which the wafer stage 10 moves during the first approach run period ΔT₁ in the Y direction:

V_{y0}ΔT₁=V_{y1}ΔT₃ (5)

If movement in the X direction is completed during the period (ΔT₃+ΔT₄), the following equation holds true:

$${V}_{x} \frac{Δ {T}_{3} + Δ {T}_{4}}{2} = {L}_{x} \qquad ( 6 )$$

where Vₓ denotes a maximum velocity in the X direction, and Lₓ denotes a distance of movement in the X direction.

Substituting ΔT₁=ΔT₄ into the above-described equations gives the periods ΔT₁, ΔT₂, and ΔT₃ as follows:

$$\begin{matrix}Δ {T}_{1} = \sqrt{\frac{2 {L}_{y}}{{a}_{2} - {a}_{1}}} & ( 7 ) \\ Δ {T}_{2} = \sqrt{\frac{2 {L}_{y}}{{a}_{2} - {a}_{1}}} ( \sqrt{\frac{{a}_{2}}{{a}_{1}}} - 1 ) & ( 8 ) \\ Δ {T}_{3} = \sqrt{\frac{2 {L}_{y}}{{a}_{2} - {a}_{1}}} \sqrt{\frac{{a}_{1}}{{a}_{2}}} & ( 9 )\end{matrix}$$

Thus, time T taken to perform one scanning exposure process can be expressed as follows:

$$T = Δ {T}_{1} + Δ {T}_{2} + Δ {T}_{3} = \sqrt{\frac{2 {L}_{y}}{{a}_{2} - {a}_{1}}} ( \sqrt{\frac{{a}_{1}}{{a}_{2}}} + \sqrt{\frac{{a}_{2}}{{a}_{1}}} ) \qquad ( 10 )$$

For example, the acceleration a₁ is set to 1.0 [G] (=9.8 [m/s²]), the deceleration a₂ is set to 5.0 [G] (=5*9.8 [m/s²]), and the dimensions of a region to be exposed are set to 20 mm wide by 30 mm long. If the dimensions of a region to be exposed at one time are 20 mm wide by 8 mm long, one scanning distance is 38 mm. Therefore, substituting L_{y}=0.038 [m] into equation (10) gives T=0.118 [s] as the time taken for one scanning exposure process.

The acceleration a₁ is not limited to 1.0 [G]. For example, if a reduction factor of the projection optical system 7 is 4, the velocity to drive the reticle stage 9 is approximately 4 times that of the wafer stage 10. This means that the acceleration of the wafer stage 10 is limited by the driving performance the reticle stage 9.

The above calculations determine the first approach run period ΔT₁ and the deceleration period ΔT₃ to be 0.044 [s] and 0.020 [s], respectively. Therefore, if the step period (ΔT₃′+ΔT₄′) in the X direction is less than or equal to 0.064 [s], it is possible to achieve efficient exposure. For example, this condition is satisfied if the acceleration of the wafer stage 10 in the X direction is greater than or equal to 2.0 [G]. In the X direction orthogonal to the scanning direction, the reticle stage 9 does not move in synchronization with the wafer stage 10. Therefore, the acceleration of the wafer stage 10 is not limited by the driving performance the reticle stage 9.

Next, for comparison with the result of the present exemplary embodiment, time taken for one exposure process in the related art is estimated.

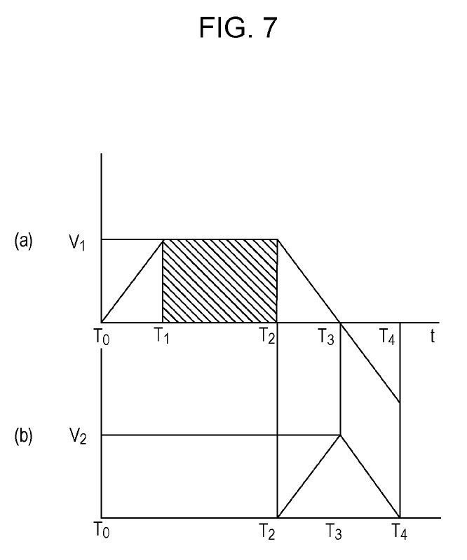

FIG. 7 illustrates a relationship between time and velocity of a wafer stage according to the related art. In FIG. 7, (a) shows the velocity of the wafer stage 10 in the Y direction (scanning direction), and (b) shows the velocity of the wafer stage 10 in the X direction (orthogonal to the scanning direction).

At time T=T₀, the acceleration of the wafer stage 10 at rest starts. Exposure starts at time T=T₁ and ends at time T=T₂. Then at time T=T₂, the deceleration of the wafer stage 10 starts. At time T=T₃, the velocity of the wafer stage 10 becomes zero. The acceleration of the wafer stage 10 in the −Y direction continues until time T=T₄.

Here, the period from time T₀ to time T₁ is defined as an acceleration period 66 T₁, the period from time T₁ to time T₂ is defined as an acceleration period ΔT₂, the period from time T₂ to time T₃ is defined as a deceleration period ΔT₃, and the period from time T₃ to time T₄ is defined as an acceleration period ΔT₄. The velocity of the wafer stage 10 at time T=T₁ is denoted by V₁.

After completion of one exposure, the wafer stage 10 performs step movement in the X direction. For this, the acceleration of the wafer stage 10 in the X direction starts at time T=T₂. In the X direction, the wafer stage 10 continues to be accelerated until time T=T₃′. Then, the wafer stage 10 is decelerated and stops at time T=T₄. The velocity of the wafer stage 10 at time T=T₃ is denoted by V₂. The acceleration period from time T₂ to time T₃ is denoted by ΔT₃, and the deceleration period from time T₃ to time T₄ is denoted by ΔT₄.

The second exposure process starts at time T=T₄. The second and subsequent exposure processes are performed in the same manner as that in the case of the first exposure process, and thus will not be described in detail here.

The velocity V₂ can be expressed by the following equation:

V₂=aΔT₁ (11)

where “a” denotes acceleration (maximum acceleration here) of the wafer stage 10 during the period ΔT₃ and ΔT₄.

The following equation holds true:

V₂ΔT₃=Lₓ (12)

where Lₓ denotes a distance between regions to be exposed adjacent in the X direction.

Since the period ΔT₃ is half the period of movement in the X direction, the following equation holds true:

$$Δ {T}_{3} = \sqrt{\frac{{L}_{x}}{a}} \qquad ( 13 )$$

The velocity V₁ of scanning exposure in the Y direction can be expressed by the following equation:

V₁=aΔT₁ (14)

The following equation holds true:

V₁ΔT₂=L_{y} (15)

where L_{y} denotes a distance of a region to be exposed in the Y direction.

Solving the above-described equations gives the periods ΔT₁ and ΔT₂ as follows:

$$\begin{matrix}Δ {T}_{1} = \sqrt{\frac{{L}_{x}}{a}} & ( 16 ) \\ Δ {T}_{2} = \frac{{L}_{y}}{\sqrt{{aL}_{x}}} & ( 17 )\end{matrix}$$

Thus, time T taken for one exposure process can be expressed as follows:

$$T = Δ {T}_{1} + Δ {T}_{2} + Δ {T}_{3} = 2 Δ {T}_{1} + Δ {T}_{2} = 2 \sqrt{\frac{{L}_{x}}{a}} + \frac{{L}_{y}}{\sqrt{{aL}_{x}}} \qquad ( 18 )$$

From here on, the acceleration a, is set to 1.0 [G] (=9.8 [m/s²]), the deceleration a₂ is set to 5.0 [G] (=5*9.8 [m/s²]), and the dimensions of a region to be exposed are set to 20 mm wide by 30 mm long. If the dimensions of a region to be exposed at one time are 20 mm wide by 8 mm long, one scanning distance is 38 mm. Therefore, substituting Lₓ=0.020 [m] and L_{y}=0.038 [m] into equation (18) gives T=0.176 [s] as the time taken for one scanning exposure process.

Thus, according to the present exemplary embodiment, it is possible to reduce time taken for scanning exposure as compared to the related art.

Here, the time taken for scanning exposure will be converted to the number of wafers processed per hour, which is a measure of performance of the exposure apparatus. For example, there are 122 regions to be exposed in a wafer that is 300 mm in diameter. It takes 4 [s] for wafer replacement and 3 [s] for wafer alignment.

Additionally, in the related art, it takes 8.6 [s] for jerking and stabilization. In the related art, the time taken for exposure is 0.176 [s]×122=21.472 [s]. As a result, it takes 37.072 [s] to process one wafer. This means that 97 wafers are processed per hour.

On the other hand, in the present exemplary embodiment, the time taken for exposure is 0.118 [s]×122=14.396 [s]. In the present exemplary embodiment, since it is not necessary to take time for jerking and stabilization, it takes only 21.396 [s] to process one wafer. This means that 168 wafers can be processed per hour.

Thus, the present exemplary embodiment achieves productivity about 1.7 times higher than that achieved in the related art.

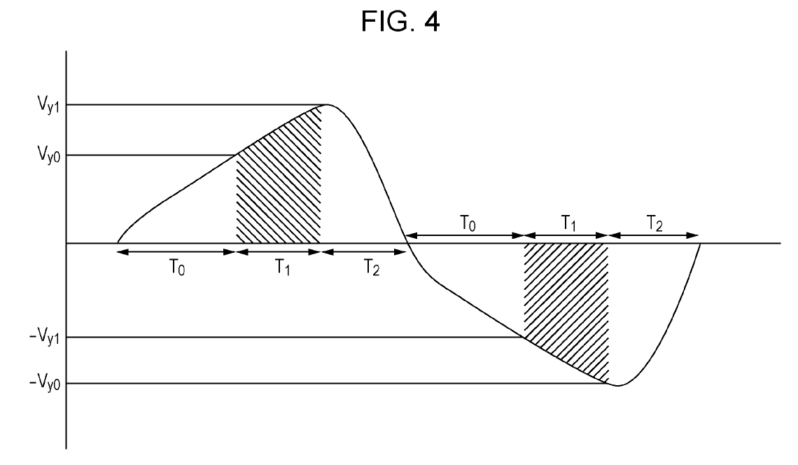

FIG. 4 illustrates a relationship between time and velocity of the wafer stage 10 according to a second exemplary embodiment of the present invention. As illustrated, an acceleration curve after completion of exposure is smoothed. Thus, the effect of deformation and vibration of the wafer stage 10 caused by a change in acceleration can be reduced.

The exposure apparatus described in the above exemplary embodiments is used to manufacture devices (e.g., semiconductor integrated circuit elements, liquid crystal display elements, etc.). A device manufacturing method includes an exposure step of exposing a wafer (substrate) coated with photoresist using the exposure apparatus, a developing step of developing the substrate, and other known steps.

The present invention makes it possible to improve throughput of a scanning exposure apparatus while minimizing degradation of exposure performance caused by deformation and vibration.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-174564 filed Jul. 3, 2008, which is hereby incorporated by reference herein in its entirety.

What is claimed is:

1. An apparatus comprising:
a substrate stage;
a driving unit configured to drive the substrate stage in a scanning direction;
an exposure unit configured to irradiate the substrate with charged particles or light for exposure; and
a control unit configured to control the exposure unit and the driving unit,
wherein the control unit controls the exposure unit and the driving unit such that exposure of a first region of the substrate starts and ends while the substrate stage is accelerated in a first direction parallel to the scanning direction;
such that an absolute value of maximum acceleration of the substrate stage during a deceleration period is greater than an absolute value during a first approach run period, the first approach run period being a period from a time when a velocity of the substrate stage is zero and acceleration starts to a time when exposure of the first region starts, the deceleration period being a period from a time when exposure of the first region ends and deceleration starts to a time when the velocity becomes zero; and
such that a distance by which the substrate stage moves during the first approach run period is approximately equal to a distance by which the substrate stage moves during the deceleration period.

2. The apparatus according to claim 1, wherein the driving unit is controlled such that acceleration of the substrate stage in a second direction during a second approach run period is equal to acceleration in the first direction during the first approach run period, the second direction being opposite the first direction, the second approach run period being a period from a time when the first deceleration period ends and acceleration of the substrate stage in the second direction starts to a time when exposure of a second region starts, the second region being a region adjacent to the first region in a direction orthogonal to the first direction and to be exposed subsequent to exposure of the first region.

3. The apparatus according to claim 1, wherein the driving unit is controlled such that acceleration of the substrate stage is constant during exposure of the first region.

4. The apparatus according to claim 1, further comprising a brake mechanism configured to assist the driving unit in decelerating the substrate stage during the first deceleration period.

5. A method comprising:
exposing a substrate using the apparatus according to claim 1; and
developing the exposed substrate.

6. A method comprising:
accelerating a substrate stage at rest until exposure starts;
exposing a first region of a substrate while accelerating the substrate stage; and
decelerating the substrate stage after completion of the exposure,
wherein an absolute value of maximum acceleration of the substrate stage in decelerating is greater than an absolute value in accelerating; and
a distance by which the substrate stage moves in accelerating is equal to a distance by which the substrate stage moves in decelerating.
